(19) United States
(12) Patent Application Publication
(10) Pub. No.: US 2001/0034237 A1
(43) Pub. Date: Oct. 25, 2001

(54) Interactive wagering system with control of unauthorized wagering

(76) Inventor: Masood Garahi, Superior, CO (US)

Correspondence Address: FISH & NEAVE, 1251 AVENUE OF THE AMERICAS, 50TH FLOOR, NEW YORK, NY, 10020-1105, US

(21) Appl. No.: 09/766,551

(22) Filed: Jan. 19, 2001

Related U.S. Application Data
(60) Provisional application No. 60/186,262, filed on Mar. 1, 2000.

(51) Int. Cl. H04Q 7/20

(52) U.S. Cl. 455/456; 455/414

(57) ABSTRACT

Systems and processes for interactive services are provided. A user-interactive application may be implemented to provide a specific service, such as a wagering service, to a user through a mobile wireless communications device. The application may be implemented partly on the mobile wireless communications device and partly in other equipment used to provide the service. The current location of the user may be determined based on determining where the user is operating the mobile wireless communications device. The application may respond differently to user selections based on where the user is currently located. For wagering systems, wagering may be prevented when the user is operating the mobile wireless communications device from a locality where wagering is not legal.

This application claims the benefit of U.S. provisional application No. 60/186,262, filed Mar. 1, 2000.

### BACKGROUND OF THE INVENTION

This invention relates to mobile wireless communications systems and more particularly, to interactive applications implemented in wireless communications systems.

Mobile wireless communications devices may allow users the opportunity to engage in a wide range activities from any where. However, many activities are regulated differently in different areas. One example of such activity is wagering. Many racing fans wager on events such as horse, dog, and harness racing. Racing fans may seek to wager using a mobile wireless communications device from anywhere, even from areas in which wagering is prohibited by law. Techniques used in known mobile wireless communications devices have not alleviated issues involved in complying with differing rules and regulations in different locality. Moreover, such known systems are not robust in providing location-appropriate features or information.

Some techniques for locating mobile wireless communications devices are known. Such techniques may include using global positioning systems, using triangulation, using homing signals. Such techniques, however, are deficient in that they may substantially increase complexity, processing, costs, etc.

It is therefore, desired to provide mobile wireless communications systems, devices, and methods that meet the demands and alleviate the drawbacks that are discussed above.

### SUMMARY OF THE INVENTION

In accordance with the principles of the present invention, systems and process may be provided for locality-based wireless applications. An application may be implemented to provide a specific service to a user of a mobile wireless communications device in an interactive system.

The application may be a wagering application, a tax calculation application, a travel-planner application, etc. The application may be implemented to configure an already operable mobile wireless communications device to provide a specific service from the mobile wireless communication device.

The interactive system may comprise a plurality of mobile wireless communications devices, a wireless communications network that is configured to serve in a plurality of localities in which the mobile wireless communications devices are operable, a user-interactive application for providing a specific service to a user (e.g., a specific service that is beyond conventional communications capabilities of a mobile wireless communications device, such as a cellular telephone), a wide area network (e.g., Internet), a host for the specific service, such as a server, etc. Different Suitable combinations of these equipment may also may be used. The mobile wireless communications device may be a cellular telephone, a two-way pager, a personal digital assistant, etc.

The application may be implemented on a mobile wireless communications device or implemented partially on a mobile wireless communications device and partially in other parts of the interactive system (e.g., partially at the host). The application may be a standalone application or may be a subpart of a particular standalone application. The application may be substantially compatible with or substantially in compliance with the Wireless Applications Protocol as published, which is a standard for developing wireless applications.

An application may be implemented to provide a service that may be restricted, regulated, or differently provided based on in which one of a plurality of localities a user is operating a mobile communications device to access the service. If desired, an application may be implemented to provide a service that may be associated with different information based on which locality. The interactive system may determine in which locality a user is operating a mobile wireless communications device. Location information for a mobile wireless communications device may be obtained from a wireless network in which the mobile wireless communications device is operating. In such applications, it is sufficiently appropriate to determine locations to general precision, such as determining a particular locality or geographic area. Location may be determined based on determining which part of a wireless communication network is being accessed by the mobile wireless communication device. Each base station in a wireless communications network in which the mobile wireless communications device is operable may have a unique identification. The mobile wireless communications device may be associated with one of the base stations. The device may be associated with one of the base stations to allow the device to have a wireless communications connection with the wireless communications network, and have a communications connection with the interactive system. The identification of a base station with which the mobile wireless communications device is associated may be used to determine a locality where the device is operating.

An application that is implemented may be controlled based on the locality information. A table may be stored that stores information on localities in which parts of a wireless communications network, such as the base stations are located and may store corresponding rules and/or information that may be associated with that locality. In a wagering application, a table may be used that identifies in which localities wagering is not legal and includes corresponding location information for base stations or parts of a wireless communications network. The table may be stored at the mobile wireless communications device, base station, host, at some other part of the interactive systems, or in combination thereof.

The locality information may be used by the application to respond differently to user selections based on which one of a plurality of different localities a user may be operating the device. A user may make a selection to access the specific service associated with that application and a response may be provided that may vary based on where the user is currently located.

A wagering application may be implemented to provide a wagering service. The wagering application may be implemented to provide a wagering service to a user from a mobile wireless communications device. A user may interact with the mobile wireless communications device to wager using the wagering application from a plurality of localities. The mobile device may have been carried by the user to the locality for use. Wagering by the user in localities in which wagering is illegal may be prevented by the wagering system. The system may determine which locality the user is currently located and may prevent wagering when the determined locality is a locality in which wagering is prohibited.

A tax calculation application may be implemented to provide a tax calculation service. The tax application may be part of a shopping or other purchasing application. The tax calculation application may be implemented to provide a tax calculation service at a mobile wireless communications device. The tax calculation application may be used during purchasing of items from the mobile wireless communications device. The tax laws that apply may vary based on in which locality purchases are made. The locality in which a mobile wireless communications device is operating may be determined and appropriate tax rules may be applied to purchases.

A weather application may be implemented to provide a weather service using a mobile wireless communications device. The weather application may automatically respond to user-selections differently based on automatically determining in which locality the user is currently located.

A travel planner application may be implemented to provide a travel planner service that is operable by a user from a mobile wireless communications device of the user. The planner application may respond to user-selection differently based on determining where the user is currently located.

Further features of the invention, its nature and various advantages will be more apparent from the accompanying drawings and the following detailed description of the preferred embodiments.

### BRIEF DESCRIPTION OF THE DRAWINGS

FIG. 1 is a flow chart of illustrative steps involved in controlling wireless applications in accordance with the present invention.

FIG. 2 is a flow chart of illustrative steps involved in providing a wireless application to a user in accordance with the present invention.

FIG. 3 is a diagram of an illustrative interactive system in accordance with the present invention.

FIG. 4 is a flow chart of illustrative steps involved in implementing wireless applications based on localities in accordance with the present invention.

FIG. 5 is a flow chart of illustrative steps involved in operating wireless application based on the identity of a base station in accordance with the present invention.

FIG. 6 is a schematic diagram of an illustrative interactive wagering system in accordance with the present invention.

FIG. 7 is a diagram of an illustrative cellular telephone in accordance with the present invention.

FIG. 8 is an illustrative initial menu screen that may be provided by the cellular telephone in accordance with the present invention.

FIG. 9 is an illustrative screen that may be provided by the cellular telephone to provide access to a telephone book feature in accordance with the present invention.

FIG. 10 is an illustrative screen that may be provided by the cellular telephone to provide access to an interactive wagering service in accordance with the present invention.

FIG. 11 is a flow chart of illustrative steps involved in controlling wagering based on location in accordance with the present invention.

FIG. 12 is a diagram of illustrative sequences of illustrative screens of a mobile wireless communications device in accordance with the present invention.

FIG. 13a is a flow chart of illustrative steps involved in providing a locality-based tax calculation application in accordance with the present invention.

FIG. 13b is a diagram of an illustrative sequence of illustrative screens of a mobile wireless communications device that is based on the illustrative steps of FIG. 13a in accordance with the present invention.

FIG. 14a is a flow chart of illustrative steps involved in providing a weather application with a current locality feature in accordance with the present invention.

FIG. 14b is a diagram of an illustrative sequence of illustrative screens of a mobile wireless communications device that is based on the illustrative steps of FIG. 14a in accordance with the present invention.

FIG. 15a is a flow chart of illustrative steps involved in providing a wireless travel planner application that varies based on the current locality in accordance with the present invention.

FIG. 15b is a diagram of an illustrative sequence of illustrative screens of a mobile wireless communications device that are based on the illustrative steps of FIG. 15a in accordance with the present invention.

### DETAILED DESCRIPTION OF THE PREFERRED EMBODIMENTS

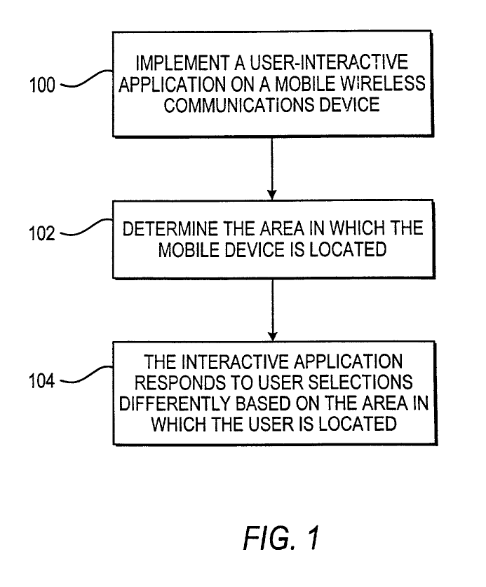

Applications in wireless communications systems may be configured to operate differently based on the area in which a device is operating. Illustrative steps involved in providing such applications are shown in FIG. 1. At step 100, a user-interactive application may be implemented (e.g., at least partly implemented) on a mobile wireless communications device to provide user-selectable features to a user operating the device. At step 102, a geographic area in which the device is located may be determined. At step 104, the interactive application may respond differently to a user selection based on the area in which the user is located.

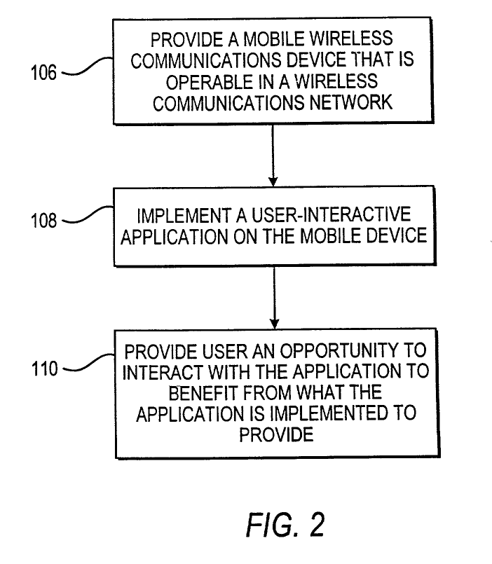

A user-interactive application may be for a particular use (e.g., wagering, shopping, etc.). Illustrative steps in providing a user-interactive application are shown in FIG. 2. At step 106, a mobile wireless communications device that is operable in a communications network may be provided. For example, a mobile wireless communications device may be provided that includes appropriate hardware and software for providing voice communications in a wireless communications network. At step 108, A user-interactive application (e.g., a wagering application) may be implemented on the mobile device. The device should have sufficient hardware and memory resources for implementing the application. The application may be implemented on the device to provide features and information beyond those are typically provided in establishing voice or data communications in a wireless communications system. At step 110, a user may be provided with an opportunity to interact with the implemented application to benefit from the purpose for which the application was implemented (i.e., what the application was implemented to provide).

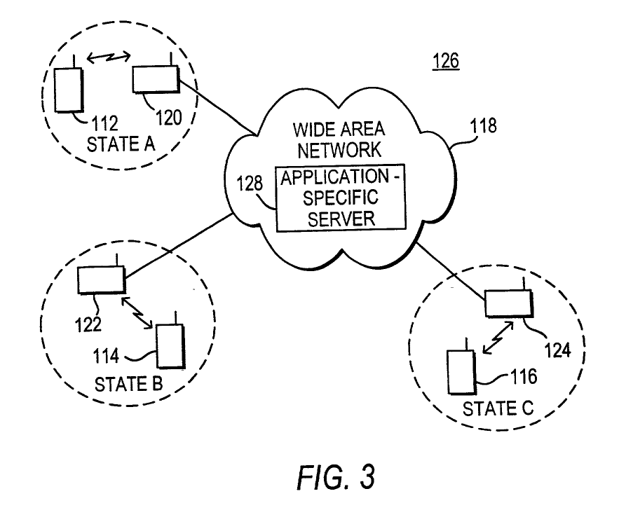

With reference now to FIG. 3, wireless communications system 126 may comprise mobile wireless communications devices 112, 114, and 116, wide area network 118, and base stations 120, 122, and 124. The illustrative steps shown in FIGS. 1 and 2 may be implemented in wireless communications system 126. Mobile devices 112, 114, and 116 may each be in a differently localities that have different rules, regulations, or information associated with the locality in which the device is located. Mobile device 112, 114, and 116 may each be associated with an appropriate one of base stations 120, 122, and 124. Mobile device 112 may be associated with base station 120 when mobile device 112 is activated in the service area of base station 120 or when mobile device 112 enters the service area of base station 120.

Base stations 120, 122, and 124 may have wireless or wireline communications connections with wide area network 118. Voice, data, or a combination thereof may be provided between wide area network 118 and mobile devices 112, 114, and 116 via base stations 120, 122, and 124. Wide area network 118 may include, among other things, application specific server 128 that may be in a client-server arrangement or other communications arrangement with mobile device 112. A specific service may be associated with server 128 (e.g., hosted by server 128) that is used in cooperation with mobile device 112 to provide the service when the user-interactive application for that service has been implemented. For clarity and brevity, server 128 is primarily discussed as being part of wide area network 118. Server 128 may be separate from wide area network 128. Communications between a server and a mobile device may be established whenever the application that is associated with server 128 is accessed for use on a mobile device in a wireless communications system that is operably coupled to wide area network 118.

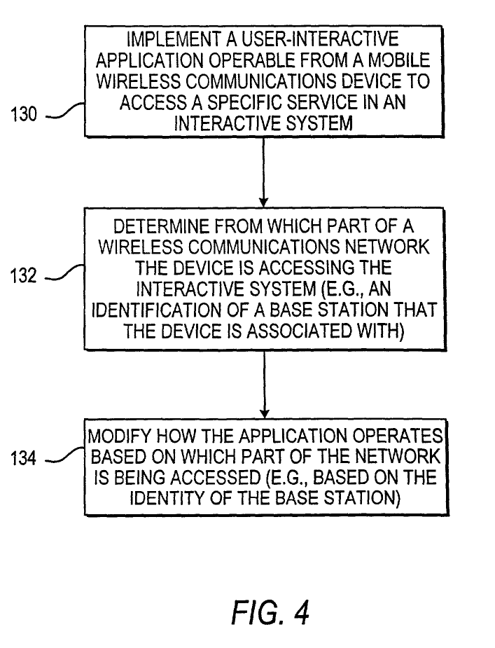

Illustrative steps involved in operating applications based on locality are shown in FIG. 4. At step 130, a user-interactive application may be implemented on a mobile wireless communications device. A user-interactive application may be implemented so that the application is operable at a mobile wireless communications device to give the user access to a specific service in an interactive system. For clarity and brevity, user-interactive applications are primarily discussed in the context of applications that are implemented on a mobile wireless communications device. Other configurations, such as the application being partially implemented on a mobile wireless communications device and partially implemented on a server, may also be used. The application may be implemented on a mobile wireless communications device that is associated with a base station.

At step 132, the interactive system (e.g., a server in the system, the device, etc.) may determine from which part of a wireless communication network the mobile wireless communication device is accessing the interactive system. For example, the identification of a base station with which the mobile device is associated is determined. The application may get the identification from the base station. The application may have an application interface with the hardware and/or software communications resources of the mobile device that allows the application to get the identification of the base station. The identification may obtained using the roaming features of most wireless protocols (e.g., cellular digital packet data, Reflex, Ram, Irdis, etc.). Typically, all base stations in wireless communications systems have unique station identifications that may be sent to the mobile wireless communications device. The station identification may be used to determine the geographic area in which a mobile communications device is located.

A user-interactive application that is implemented on a mobile communications device may initiate a handshake with the communications network of the wireless communications service provider (e.g., a handshake through a cell site, transceiver, etc.). The application may initiate the handshake using an application interface that allows access to resources that control wireless communications operations. The mobile wireless communications device may send its own identification information to the wireless system (e.g., identification may be sent when the mobile device is first powered, when the device enters a cell, when the application is selected to be used on the device, etc.) and the wireless system may send system identification information (e.g., base station identification) to the mobile device. The system (e.g., the base station associated with the mobile device) may also send identification information of the mobile device and system identification information (e.g., the base station identification) to an application-specific system (e.g., a server that interacts with service subscribers to provide a service to subscriber when an application that is implemented for that service is used from a subscriber's mobile device).

The identification information for the wireless system (e.g., base station identification information) may be examined to determine the locality in which the mobile device is operating. For example, the identification information may be examined against a table of system identifications to identify appropriate information, rules, or regulations that are associated with the locality in which the mobile device is operating. The table may be stored in one of the equipment shown in FIG. 3 (e.g., stored in a base station 120) or in a combination of the equipment shown in FIG. 3 (e.g., may be stored at base station 120, partly stored at server 129 and partly stored at mobile device 122, etc.).

At step 134, the interactive system may modify how the application operates based on which part of a wireless communications network is accessed by the mobile wireless communications device. For example, a mobile device may be determined to be accessing a wireless communications network from a base station or a telecommunications switch that is in a particular locality and the interactive system may modify how the application responds when the application is used in that locality. Operations that are prohibited, restricted, or regulated differently in that locality may be automatically adopted to modify how the application operates and interacts with the user of the mobile wireless communications device. Moreover, information that is associated with that locality may be provided to enhance the operation of the application.

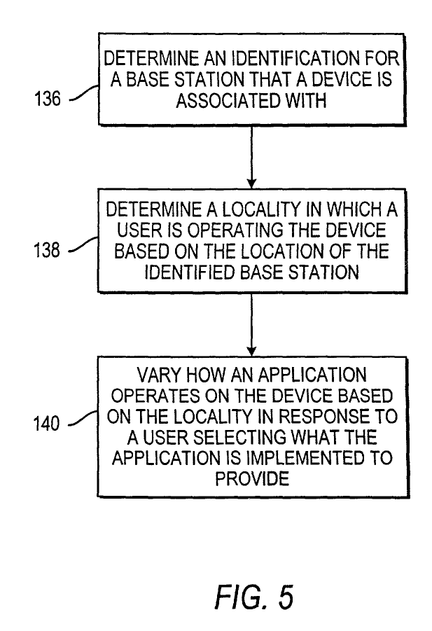

Illustrative steps involved in providing an application that operates differently based on locality are shown in FIG. 5. At step 136, identification information may be determined for a base station with which a mobile wireless communications device is associated. The base station may be part of a wireless communications system or network that uses unique identifications for each base station used. The base station identification may be a simple and efficient key to identifying the approximate location of mobile wireless communications devices that are associated with base stations. At step 138, the locality in which a user is operating a mobile device is determined based on location information for an identified base station. Location information may be determined using a table for matching base station identifications with localities. The table may be implemented at the mobile wireless communications device, at the base station, at a server that is in a communications arrangement with the mobile device, or a combination thereof. An advantage of using a table is that information may be quickly applied and determined. Other techniques for obtaining location information from identification information of a wireless communications system may also be used.

At step 140, the operation of the applications (i.e., how the application operates) may be varied based on the locality in response to a user selecting what the application is implemented to provide. The application may have been implemented to provide features for providing wagering. The operation of the application may be varied based on where the user is located in response to a user selecting the features of that application.

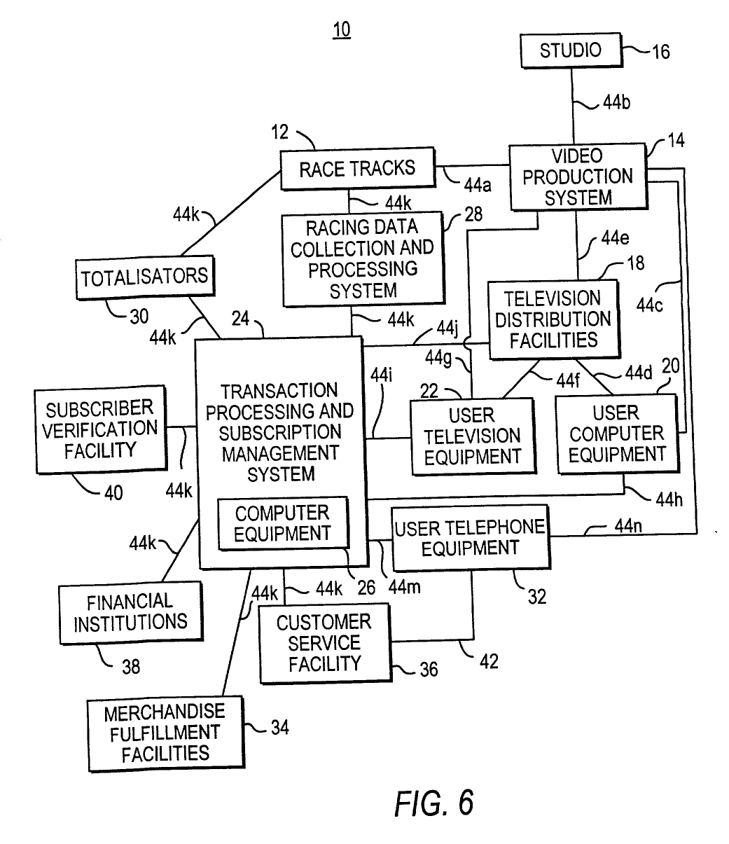

Locality based operation of interactive applications implemented on a mobile wireless communications device may be provided for interactive wagering systems. An illustrative interactive wagering system 10 is shown in FIG. 6. Aspects of the wagering system apply to various different types of wagering, but are described herein primarily in the context of interactive wagering on races (e.g., horse races) for specificity and clarity. Races may be run at racetracks 12, which may be located at various geographic locations. Races run at the racetracks may be simulcast to television viewers. For example, simulcast videos may be provided to users with satellite receivers or to off-track betting establishments via satellite.

Real-time videos from racetracks 12 may also be provided to video production system 14 for distribution to users as part of a television wagering service (i.e., a wagering-related television channel or Internet-delivered service or the like). If desired, multiple simulcast videos may be provided to video production system 14 in real-time. Talent (e.g., commentators) for the television wagering service may be located at studio 16. Studio 16 may provide a video feed containing commentary and the like to video production system 14. Graphic overlays for the television wagering service may be added to the service at video production system 14.

The television wagering service may be provided by using video production system 14 to combine selected video segments from desired racing simulcasts with the video feed from studio 16 and suitable graphic overlays. If desired, video production system 14 or a separate facility may be used to reformat simulcasts from racetracks 12. For example, if racetracks 12 provide simulcasts as traditional analog television channels, video production system 14 (or a separate facility) may convert these simulcasts or portions of these simulcasts into digital signals (e.g., digital video signals) or into a different number of analog signals. Digital video signals may require less bandwidth than analog video signals and may be appropriate for situations in which videos are to be transmitted over either high or low bandwidth pathways. Low bandwidth pathways may include telephone lines, the Internet, etc.

Video production system 14 may provide a television wagering service that includes selected simulcast videos, video from studio 16, and graphic overlays to television distribution facilities 18 (for redistribution to user television equipment 22 and user computer equipment 20), to user computer equipment 20, and to user telephone equipment 32 (if user telephone equipment 32 has a display capable of displaying moving images). Television distribution facilities 16 may be any suitable facilities for supplying television to users, such as cable system headends, satellite systems, broadcast television systems, or other suitable systems or combinations of such systems. User computer equipment 20 may be any suitable computer equipment that supports an interactive wagering application. For example, user computer equipment 20 may be a personal computer. User computer equipment 20 may also be based on a mainframe computer, a workstation, a networked computer or computers, a laptop computer, a notebook computer, a handheld computing device such as a personal digital assistant or other small portable computer, etc.

Each of television distribution facilities 18 is typically located at a different geographic location. Users with user television equipment 22 may receive the television wagering service from an associated television distribution facility. User television equipment 22 may include, for example, a television or other suitable monitor. A television may be used to watch the television wagering service on a traditional analog television channel. User television equipment 22 may also include a digital or analog set-top box connected to a television distribution facility 16 by a cable path. A digital set-top box may be used to receive the television wagering service on a digital channel. If desired, user television equipment 22 may contain a satellite receiver, a WebTV box, a personal computer television (PC/TV), or hardware similar to such devices into which set-top box capabilities have been integrated. A recording device such as a videocassette recorder or digital recording device (e.g., a personal video recorder or digital video recorder based on hard disk drives or the like) may be used in user television equipment 22 to store videos. The recording device may be separate from or part of the other components of user television equipment 22.

User computer equipment 20 may receive the television wagering service using a video card or other video-capable equipment to receive analog or digital (e.g., moving picture experts group or MPEG) videos from a television distribution facility. User computer equipment 20 may also receive the television wagering service directly from video production system 14 using, for example, a modem link. If desired, the video for the television wagering service may be compressed (e.g., using MPEG techniques). This may be useful, for example, if the path to user computer equipment 20 is a modem connection using telephone links. If video production system 14 is only used to serve user computer equipment 20 without traditional analog television capabilities, video production system 14 may only need to supply such digitally-compressed video signals and not analog television signals.

Video clips of races and other simulcast information may be provided to users in the form of a television wagering service or an interactive wagering service. If desired, race-related videos may be provided to the user by using video production system 14 or other suitable equipment to route appropriate video clips from the simulcasts to the user in real time. Video clips may also be stored for later viewing. For example, one or more video servers located at racetracks 12, video production system 14, television distribution facilities 18, or other suitable locations may be used to store video clips. The stored videos may then be played back in real time or downloaded for viewing at user television equipment 22, user computer equipment 20, or user telephone equipment 32. The video clips may contain videos of races, commentary, interviews with jockeys, or any other suitable race-related information. If desired, real-time or stored videos may be provided from racetracks 12 directly to user television equipment 22, user computer equipment 20, or user telephone equipment 32 over the Internet or other suitable communications paths without involving video production system 14. Videos may also be provided by routing video signals through equipment located elsewhere in system 10. For example, videos may be routed through transaction processing and subscription management system 24.

Transaction processing and subscription management system 24 may contain computer equipment 26 and other equipment for supporting system functions such as transaction processing (e.g., handling tasks related to wagers, product purchasing, adjusting the amount of funds in user accounts based on the outcomes of wagers, video clip ordering, etc.), data distribution (e.g., for distributing racing data to the users), and subscriber management (e.g., features related to opening an account for a user, closing an account, allowing a user to add or withdraw funds from an account, changing the user's address or personal identification number, etc.). Databases within transaction processing and subscription management system 24 or associated with system 24 may be used to store racing data, wagering data and other transaction data, and subscriber data such as such as information on the user's current account balance, past wagering history, individual wager limits, personal identification number, billing addresses, credit card numbers, bank account numbers, social security numbers, etc. Using such databases may allow the user to access information more quickly and allows for central administration of the wagering service.

If desired, racing videos and other services may be provided using servers and other equipment located at transaction processing and subscription management system 24. For example, video clips may be provided to the user on-demand. Interactive advertisements may be provided to the user. When the user selects a desired advertisement, transaction processing and subscription management system 24 may provide additional information or other services related to the advertisement to the user.

Product ordering services may be implemented using computer equipment at transaction processing and subscriber management system 24 to handle orders and to assist in adjusting the appropriate account of the user accordingly. Orders may be fulfilled using merchandise fulfillment facilities 34. Merchandise fulfillment facilities 34 may be operated solely to provide merchandise fulfillment or may be associated with independently-operated mail-order or on-line businesses. Similar facilities may be used to allow users to order services.

Statistical racing data such as the post times for each race, jockey names, runner names and the number of races associated with each track, handicapping information (e.g., information on past performances such as the number of wins and losses for the past year, etc.), and weather conditions at various tracks may be provided by racing data collection and processing system 28. Some of the data may be collected from racetracks 12 and some may be provided by third party information sources such as Axcis Pocket Information Network, Inc. of Santa Clara, Calif. or other suitable data sources.

Racing data may also be provided from totalisators 30. Totalisators 30 are the computer systems that may be used to handle wagers made at the racetracks, made at off-track betting establishments, and made using interactive wagering system 10. Totalisators 30 generate wagering odds in real time. Totalisators 30 generate these odds based on information on which wagers are being placed (e.g., based on information on which wagers are being placed on races at racetracks 12). Totalisators 30 are available from companies such as Amtote International, Inc. of Hunt Valley, Md. Totalisators 30 may be associated with individual racetracks 12 or groups of racetracks 12. Totalisators 30 may communicate with one another using a communication protocol known as the Intertote Track System Protocol (ITSP). This allows totalisators 30 to share wagering pools. Totalisators 30 may provide racing data including information on the current races at racetracks 12, the number of races associated with each racetrack, win, place, and show odds and pool totals for each horse or other runner, and exacta, trifecta, and quinella payoff predictions and pool totals for every possible combination of runners. Totalisators 30 may also provide current odds and other real-time racing data for other types of wagers. Totalisators 30 may provide the time until post time for each race.

Totalisators 30 may provide race results, such as the order-of-finish list for at least the first three positions and payoff values versus a standard wager amount for win, place, and show, for each runner in the finish list. Payoff values may be provided for winning complex wager types such as exacta, trifecta, quinella, pick-n (where n is the number of races involved in the pick-n wager), and daily double. The payoff values may be accompanied by a synopsis of the associated finish list.

Totalisators 30 may also provide program information of the type typically provided in printed racing programs. Such program information may include early odds, early scratches, race descriptions (including the distance of each race and the race surface—grass, dirt, artificial turf, etc.), allowed class ratings (based on a fixed ratio of external criteria), purse value (payoff to winning runner), allowed age range of runners, and the allowed number of wins and starts for each runner.

If desired, some of the information provided to transaction processing and subscription management system 24 by totalisators 30 (such as the program information or other suitable racing data) may be provided by racing data collection and processing system 28. Similarly, some of the information provided to transaction processing and subscription management system 24 by racing data collection and processing system 28 may be provided by totalisators 30. Moreover, the foregoing examples of different suitable types of racing data are merely illustrative. Any suitable data related to racing may be provided to transaction processing and subscription management system if desired.

Transaction processing and subscription management system 24 provides the racing data to users at user television equipment 22, user computer equipment 20, and user telephone equipment 32 for use in following race results and developing wagers. If desired, racing data may be provided to users using paths that do not directly involve transaction processing and subscription management system 24. For example, racing data may be provided from racing data collection and processing system 28 to user television equipment 22, user computer equipment 20, or user telephone equipment 32 using the Internet or other suitable communications paths.

User telephone equipment 32 may be a conventional telephone, a cordless telephone, a mobile wireless communications device, such as a cellular telephone, two-way pager, handheld computer, personal digital assistant or any other suitable telephone equipment. Mobile wireless communications devices should have audible or visual display indicators, sufficient hardware and software capability to support two-way communications and to implement a wagering or other application on the device, input interface for allowing a user to make selection or take actions in connection with communications and implemented applications. Applications that are implemented on a mobile wireless communications device may be implemented to provide features such as wagering or shopping that are in addition to communications capabilities of a mobile wireless communication device. Applications may be implemented as subparts of other applications. Applications may be implemented in combination with other applications (e.g., a wagering application that is implemented through a Web site when using an Internet browser type application).

Users at user television equipment 22 and user computer equipment 20 may view information on the racing data on a television or other suitable monitor. Users at user telephone equipment 32 may listen to racing data using an interactive voice system. User telephone equipment 32 may be mobile wireless communications devices, such as cellular telephones with displays. Users may view racing data displayed on such displays.

Users who wish to place wagers may establish an account at transaction processing and subscription management system 24. An account may also be established at one of totalisators 30. The user and the interactive wagering services may have their own bank accounts at financial institutions 38. A user may set up an account electronically by using user television equipment 22, user computer equipment 20, or user telephone equipment 32 to interact with the subscriber management functions of transaction processing and subscription management system 24. If desired, accounts may be established with the interactive wagering service with the assistance of customer service representatives at customer service facility 36. Customer service facility 36 may be at the same location as transaction processing and subscription management system 24, may be part of system 24, or may be located remote from system 24. Customer service representatives at customer service facility 36 may be reached by telephone. If user telephone equipment 32 is used to access the interactive wagering service, for example, user telephone equipment 32 may be used to reach the customer service representative using communications path 42. If user television equipment 22 or user computer equipment 20 is being used with the service, a telephone at the same location as that equipment may be used to reach the customer service representative. The user's identity may be checked using social security number information or other identification information with the assistance of subscriber verification facility 40. The services of subscriber verification facility 40 may be used to ensure that the user lives in a geographic area in which wagering is legal, that the user is of a legal age, and that the identification information (e.g., the user's social security number) matches the name provided by the user. If the user is using a mobile wireless communications device, the user's present physical location may be determined by determining which general part of the cellular telephone network is being accessed by the user. The location information may be used to verify that the user is located in a geographic area where wagering is not illegal.

In a typical enrollment process, the user provides personal information to the interactive wagering service and provides funds with a credit card or funds from the user's bank account. The interactive wagering service sets up an account for the user at transaction processing and subscription management system 24 and directs one of totalisators 30 to set up a new account for the user at the totalisator. The totalisator is also directed to credit the user's account to reflect the amount of funds provided by the user. After the user places a wager and wins or loses, the totalisator adjusts the user's totalisator account to reflect the outcome of the wager. The totalisator may periodically inform the interactive wagering service of the adjusted balance in the user's account. This may be accomplished using any suitable technique (e.g., periodically, continuously, on-request, etc.). For example, reports may be collected periodically (e.g., once a day in an end-of-day report) and provided to the interactive wagering service to reconcile the account balances at transaction processing and subscription management system 24 with the account balances at totalisators 30.

If the user makes a balance inquiry, the inquiry may be passed to the appropriate totalisator by transaction processing and subscription management system 24. If the user is charged a fee for subscribing to the service, the service may debit the fee from the user's account at the transaction processing and subscription management system 24.

The accounts at totalisators 30 and transaction processing and subscription management system 24 are typically maintained separately, because the business entities that operate totalisators 30 and transaction processing and subscription management system 24 are independent. If desired, financial functions related to opening and maintaining user accounts and the like may be handled using computer equipment at another location such as one of financial institutions 38 or other location remote from totalisators 30 and system 24. Such financial functions may also be implemented primarily at a totalisator 30 or primarily at the transaction processing and subscription management system 24 if desired.

Users at user television equipment 22, user computer equipment 20, and user telephone equipment 32 may place wagers by providing wagering data and otherwise interacting with transaction processing and subscription management system 24. The interactive wagering service may provide a user at user television equipment 22, user computer equipment 20, or user telephone equipment 32 that has display capabilities with screens containing various racing data. For example, the user may be presented with screens that allow the user to view the current odds for horses in an upcoming race at a given track.

The service may provide the user with interactive screens containing menus and selectable options that allow the user to specify the type of wager in which the user is interested and the desired wager amount. With a set-top box arrangement, for example, the user may use a remote control or wireless keyboard to navigate the various menus and selectable options. With a personal computer, the user may use a keyboard, mouse, trackball, touch pad, or other suitable input or pointing device. With a cellular telephone with a display, the user may use buttons on the telephone. When the user has made appropriate selections to define a desired wager, the user television equipment, user computer equipment, or user telephone equipment may transmit wagering data for the wager to transaction processing and subscription management system 24.

Users with telephones may also interact with the service using an interactive voice response system located at transaction processing and subscription management system 24. The interactive voice response system may present menu options to the user in the form of audio prompts (e.g., “press 1 to select a $2 wager amount,” etc.). The user may interact with the service by pressing the corresponding buttons on a touch tone telephone. User telephone equipment 32 that is based on cellular telephones allows the user to interact with the wagering service in this way. User telephone equipment 32 that is based on cellular telephones with messaging and display capabilities also allows the user to interact visually with the interactive wagering service. User telephone equipment 32 may be cellular-based mobile communications devices.

The components of system 10 may be interconnected using various communications paths 44. Communications paths 44 may include satellite paths, coaxial cable paths, fiber-optic paths, twisted pair paths, other wire or cable-based links, wireless paths through free space, or any other suitable paths or combination of such paths. Communications over paths 44 may involve analog transmissions, digital transmissions, wireless transmissions, microwave transmissions, radio-frequency transmissions, optical transmissions, audio transmissions, or any other suitable type of transmissions or combination of such transmissions. Communications may involve Internet transmissions, private network transmissions, packet-based transmissions, television channel transmissions, transmissions in the vertical blanking interval of a television channel or on a television sideband, MPEG transmissions, etc. Communications may involve one-way or two-way wireless pager or other messaging transmissions. Communications paths 44 may include cable connected to cable modems, digital subscriber lines, integrated services digital network (ISDN) lines, or any other suitable paths. Examples of suitable communications paths are described below. Those examples are, however, merely illustrative. Any of the communications path arrangements described above or other suitable arrangements may be used if desired.

Communications paths that carry video and particularly uncompressed analog video or lightly-compressed or full-screen digital video generally use more bandwidth than communications paths that carry only data or that carry partial-screen digital video. For example, if it is desired to transmit high-quality simulcasts of races from racetracks 12 to video production system 14, analog or digital videos may be transmitted from racetracks 12 to video production system 14 over path 44a using satellite links. Video may be transmitted from studio 16 to video production system 14 over path 44b using a satellite link or a high-speed terrestrial path such as a fiber-optic path. Studio 16 may also be located at the same site as video production system 14, thereby avoiding the need for a long-haul transmission path. Videos may be transmitted from video production system 14 to user computer equipment 20 over path 14c using a modem link (using, for example, a digital subscriber line, a telephone network link, a wireless link etc.) The modem link may be made over a private network.

A user with a cable modem may connect a personal computer or other such user computer equipment 20 to an associated cable system headend using path 44d. (The headend in such an arrangement would be one of the television distribution facilities 18 shown in FIG. 1.) The user may then receive videos from the headend via cable modem. Videos may be provided to the headend over path 44e using a network link, fiber optic links, cable links, microwave links, satellite links, etc. A user with a set-top box or similar device (shown in FIG. 1 as user television equipment 22) may also receive videos from a cable system headend using a cable modem or other such communications device over path 44f. In addition, a user with user television equipment may receive videos over the Internet or a private network using a telephone-based modem or other such communications device using path 44g. In a system with distributed processing, interactive wagering services may be provided using a television distribution facility 18 that includes equipment that supplements or replaces at least some of the equipment at transaction processing and subscription management system 24.

If desired, user television equipment 22 or user computer equipment 20 may receive analog or digital videos from an associated television distribution facility over the communications paths normally used to distribute television programming (e.g., paths 44f and 44d). For example, videos may be received as part of a dedicated interactive wagering service television channel. If videos are provided as digital signals (e.g., MPEG signals), 10 or more digital videos may be carried on a single analog channel (or one digital video may be carried on one-tenth of the bandwidth of an analog channel). If the videos are not full-screen videos, even more videos may be simultaneously provided without a loss of image quality.

Racing videos may be provided to user telephone equipment 32 over a partially-wireless telephone Internet link or other telephone link using path 44n.

If desired, racing data may accompany the racing videos along any of these paths. Moreover, racing videos may be provided by routing them directly from racetracks 12 to user television equipment 22, user computer equipment 20 (e.g., over the Internet or a private network, etc.), or user telephone equipment 32. Racing videos may also be provided by routing them through transaction processing and subscription management system 24. If a cellular telephone or portable computing device has sufficient display capabilities to support moving images, racing videos may be displayed. Such videos may be provided using any suitable path, such as a direct path from racetracks 12, a path through video production system 14 or other suitable video processing equipment, through a hub such as transaction processing and subscription management system 24, etc. Racing videos may be provided in real time or may be recorded for later distribution. Videos that are not provided in real-time may be downloaded by user television equipment 22, user computer equipment 20, a cellular telephone, or other suitable user equipment at a lower data rate than would otherwise be required and may be downloaded in the background if desired. Such videos may also be provided to the user at real-time video rates for direct viewing by the user.

Racing data and other information related to the interactive wagering service may be provided to users over paths connected to transaction processing and subscription management system 24. For example, racing data and other data for the service may be provided to user computer equipment 20 over path 44h using a modem link. Path 44h may be a private network path or an Internet path. Path 44h may use telephone lines, digital subscriber lines, ISDN lines, wireless data paths, or any other suitable type of communications links. User television equipment 22 may receive data for the wagering service over communications path 44i, which may be a telephone line, digital subscriber line, ISDN line, or other suitable type of communications path and which may use a private network path or an Internet path, etc.

Data for the wagering service may be provided to users via communications path 44j and paths 44f and 44d. Communications path 44j may be provided over a private network, using the public telephone network, using satellite links, or any other suitable type of links. Data from paths such as path 44j may be routed to paths such as paths 44f and 44d directly by associated television distribution facilities 18, or may be buffered at television distribution facilities 18 if desired. Paths 44f and 44d may include coaxial cable and use of paths 44f and 44d may involve the use of cable modems or the like. If data is provided over path 44j and path 44f or path 44d using an Internet protocol, a web browser or similar application running on user television equipment 22 or user computer equipment 20 may be used to access the data. Such application software may also be used to view videos and may be used on other platforms (e.g., advanced cellular telephones) if desired.

The communications paths 44k that are used to connect various other components of the system typically do not carry high-bandwidth video signals. Accordingly, paths 44k may be telephone-like paths that are part of the Internet or a private network. Such paths and various other paths 44 may be dedicated connections for security, reliability, and economy.

User telephone equipment 32 may receive information for the wagering service via path 44m. If user telephone equipment 32 is a standard telephone, such information may be in the form of audio prompts (“press 1 to place a wager”) and audio racing data (“the current win odds for horse 2 are 5-1”). Transaction data processing and subscription management system 24 may contain interactive voice response equipment that provides such information to the user and that responds to touch-tone signals from the user when the user responds to prompts by pressing buttons on the user's telephone.

If user telephone equipment 32 is a mobile wireless communications device, such as a cellular telephone, racing data and other information for the interactive wagering service may be provided to the user by using a wireless connection, such as a cellular wireless connection, as part of path 44m. Users with cellular telephones may be provided with audio prompts using an interactive voice response system located at transaction processing and subscription management system 24 to which the users may respond by pressing cellular telephone buttons to generate touch-tone signals.

Racing data and other information for the interactive wagering service may be provided to mobile wireless communications devices, such as cellular telephones in the form of alphanumeric messages. Such messages may be transmitted to the user by using paging or other alphanumeric messaging formats or any other suitable data communications scheme. If desired, data may be provided to the cellular telephones over the voice channel and decoded by the cellular telephone using modem circuitry or other suitable circuitry. Data may also be provided using any other suitable cellular or wireless path. Regardless of the way in which racing data and other information for the interactive wagering service are provided to the mobile wireless communications devices, such information may be provided to the user by displaying it on the display screen of the mobile wireless communications device or by presenting it in audible form through the speaker of mobile wireless communications devices that have audio capabilities (e.g., cellular telephones).

Racing data and other interactive wagering service information for the users may be provided in one or more continuous data streams, may be provided periodically (e.g., once per hour or once per day), or may be provided using a client-server arrangement in which data is requested by a client processor (e.g., user television equipment 22, user computer equipment 20, user telephone equipment 32, or any other such equipment) from a server (e.g., a server implemented using computer equipment 26 at transaction processing and subscription management system 24 or computer equipment at another suitable location). Videos may also be provided using any of these techniques.

A return communications path between the user and the interactive wagering service may be used to allow the user to place wagers and otherwise interact with the interactive wagering service. For example, a user with a standard telephone or a cellular telephone may interact with the service by pressing touch-tone keys on the telephone in response to audio prompts provided by an interactive voice response system at transaction processing and subscription management system 24. If desired, users may call customer service representatives at customer service facility 36 and place wagers with manual assistance. The user of a cellular telephone may interact with the wagering service by selecting menu options and otherwise interacting with information displayed on the cellular telephone. When a selection is made, software implemented on the telephone may be used to assist the user in transmitting appropriate data (e.g., wagering data) to the wagering service. Such data may be transmitted using any suitable technique. For example, data may be transmitted using a wireless data link that is separate from the cellular voice channels. Data may also be transmitted over the voice channel (e.g., using a modem built into the cellular telephone, by automatically generating touch-tone signals that may be recognized by the interactive voice response system at transaction processing and subscription management system 24, or using any other suitable arrangement). These approaches may be used even if the user receives racing data and other information for the service using a platform other than a telephone-based platform.

If desired, the return communications path between the user and the interactive wagering service may use paging transmissions. For example, a cellular telephone or other mobile wireless communications device with two-way paging capabilities may be used to place wagers and otherwise interact with the interactive wagering service using paging transmissions.

Users with user television equipment 22 may interact with the service by sending data (e.g., wager data) to transaction processing and subscription management system 24 using path 44i or using paths 44f and 44j. Users with user computer equipment 20 may send data (e.g., wager data) to transaction processing and subscription management system 24 via path 44h or paths 44d and 44j. Users at any user equipment may send data for the service to locations other than transaction processing and subscription management system 24. For example, the user may provide information directly to customer service facility 36, etc.

If desired, the user may send data to the service at transaction processing and subscription management system 24 using different paths than those used to receive data from transaction processing and subscription management system 24. For example, racing data may be received at user television equipment 22 via paths 44j and 44f, whereas data may be sent by the user from user television equipment 22 to transaction processing and subscription management system 24 using path 44i, etc. Moreover, the paths used to receive certain video information may be different from those used to receive racing data. For example, user television equipment 22 may receive racing videos using path 44f, but may receive racing data using path 44i. These examples are merely illustrative. Any suitable combination of paths may be used to distribute racing data and other information for the interactive wagering service, any suitable combination of paths may be used to receive videos, and any suitable combination of paths may be used to send data to the wagering service.

If desired, the user may interact with the wagering service using more than one platform. For example, the user may place a wager using a cellular telephone while the user is driving home. When the user arrives home, the user may determine the outcome of the wager by watching a video of the race on user television equipment. Later in the day, the user may check the user's account balance using a personal computer. This is merely an illustrative example. The various wagering platforms may be used in any suitable combination.

Although system 10 has been described in the context of a system that supports multiple wagering platforms, system 10 may support fewer platforms if desired. For example, system 10 may be implemented to only support wagering with mobile wireless communications devices. If desired, system 10 may be configured so that it does not support personal computer wagering, wagering with standard telephones, or wagering with user television equipment. The system may support mobile wireless communications devices, such as cellular telephones, handheld computing devices such as personal digital assistants, palm-sized computers, etc. in combination with any other suitable platform.

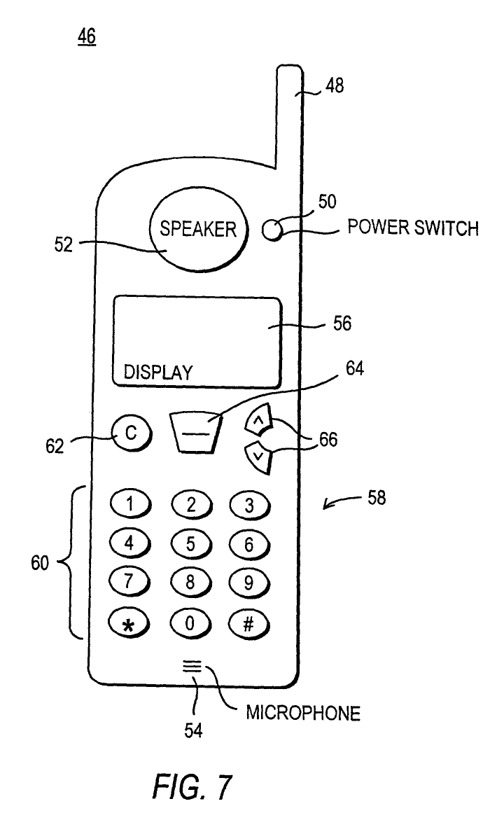

An illustrative cellular telephone 46 with which the user may use the interactive wagering service is shown in FIG. 7. Software for the interactive wagering service may be used at transaction processing and subscription management system 24 and each of the other components shown in FIG. 6. A portion of the software that is used to implement the interactive wagering service is resident on cellular telephone 46. Cellular telephone 46 may have a memory for storing software instructions and a processor for executing those instructions. If desired, at least some of the interactive wagering features described herein may be implemented using a handheld computing device or personal digital assistant such as the Palm V or Palm VII devices of Palm Computing Inc. (a 3Com company) of Mountain View, Calif. instead of a cellular telephone. For clarity and simplicity, however, the invention will be described primarily in connection with wireless mobile communications devices and in connection with wireless communications devices that are cellular telephones.

Cellular telephone 46 may have an antenna 48 to support wireless communications with transaction processing and subscription management system 24. Communications between telephone 46 and system 24 may use communications path 44m of FIG. 6. Path 44m may include both a wireless portion (e.g., the link from cellular telephone 46 to a nearby antenna connected to the cellular network) and a non-wireless portion (e.g., non-wireless links in the public telephone network).

A power switch 50 (FIG. 7) may be used to turn on and off cellular telephone 46. A speaker 52 allows the user to hear conversations and to hear audio prompts from transaction processing and subscription management system 24. A microphone 54 allows the user to converse with others. Display 56 may be a liquid crystal display (black and white or color), a plasma display, a light-emitting diode display, an active matrix display, or any other suitable type of small display screen. Keys 58 allow the user to enter inputs. Numeric keys 60 (including the star and pound key) allow the user to respond to interactive voice response system prompts such as “press 3 to select race 3” and allow the user to enter numbers to select numerically identified on-screen menu options and the like that are displayed on display 56. If desired, some of the numeric keys 60 may perform secondary functions if, for example, they are pressed and held for at least a predetermined length of time. Clear key 62 may be used to clear characters from display 56. If the user presses and holds clear key 62, the user may be taken back to the initial screen displayed on display 56 upon power up. Navigation key 64 may be used to access menus, make telephone calls, etc. Scroll keys 66 may be used to scroll through menus and to scroll through other items presented on display screen 56.

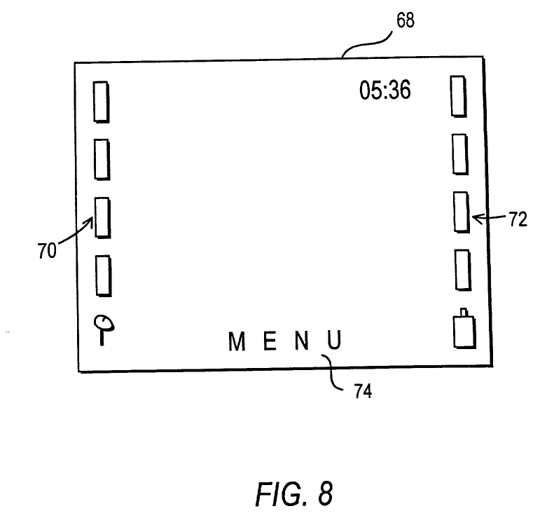

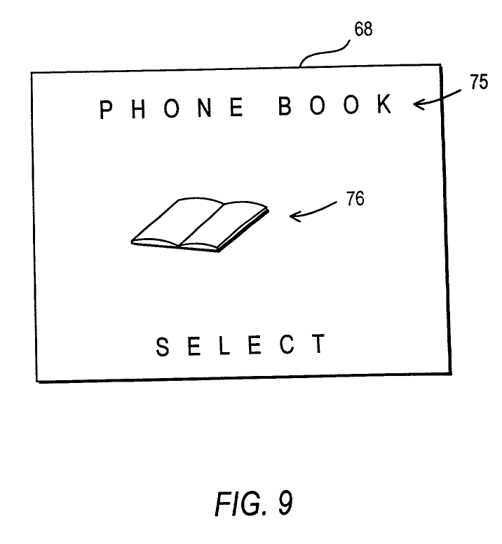

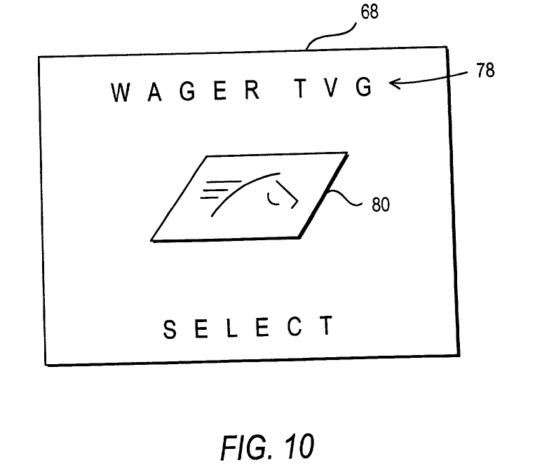

As shown in FIG. 8, when cellular telephone 46 is initially turned on, a screen 68 having a signal strength indicator 70 and a battery level indicator 72 may be presented to the user on display 56 (FIG. 7). Screen 68 of FIG. 8 may be provided with “MENU” label 74. Pressing the down scroll key 66 (FIG. 7) directs cellular telephone 46 (FIG. 7) to display screen 68 of FIG. 9, which includes a menu option label 75 and corresponding icon 76 for a phone book service. As shown in FIG. 10, if the user subsequently presses down scroll key 66, the cellular telephone 46 may display a screen containing the name 78 and logo 80 of a television wagering service or the like.

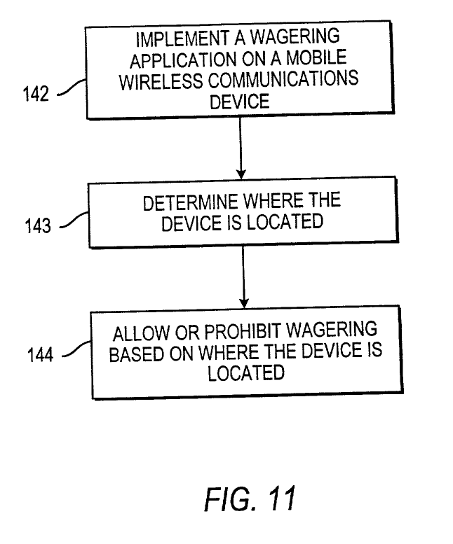

Illustrative steps involved in controlling illegal wagering are shown in FIG. 11. At step 142, a wagering application may be implemented on a mobile wireless communications device. The mobile wireless communications device may be a device that is operable in a wireless communications system with or without the wagering application. At step 143, the locality or geographic area in which the device is located may be determined. The determination may be made based on the techniques discussed above (e.g., based on the identification of a base station that is associated with the mobile wireless communications device). At step 144, the application may block a user from wagering when the user is operating the device in a geographic area where wagering is illegal and allow a user to wager when the user is operating the device in a geographic area where wagering is not illegal. Techniques for controlling the operation of the application based on the locality are discussed above.

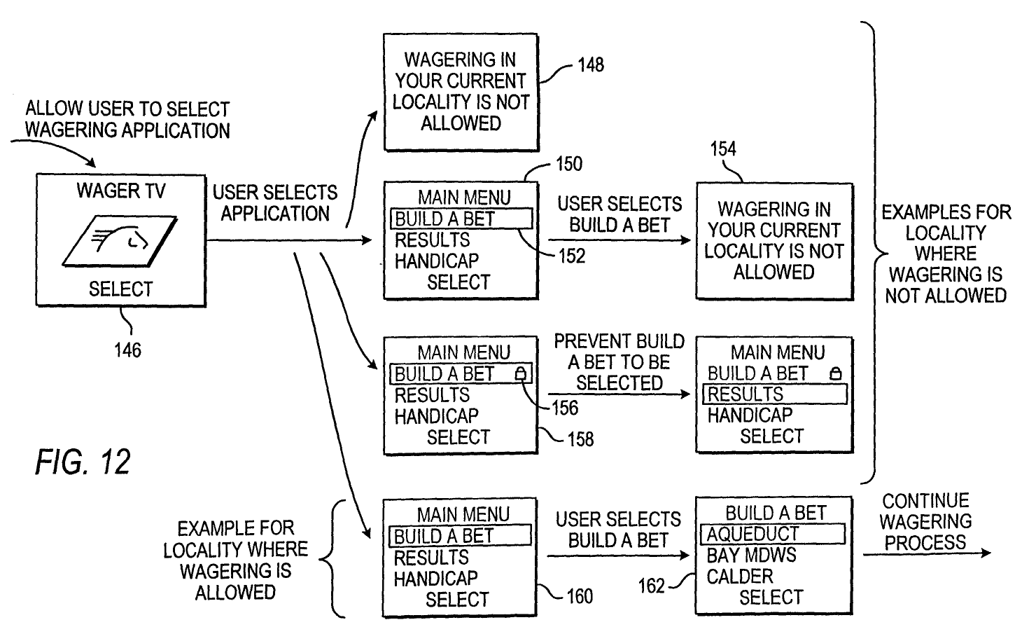

FIG. 12 shows four different illustrative sequences of screens that may be presented in an interactive wagering system, such as the illustrative interactive wagering system of FIG. 6. Screen 146 may be presented when a user uses a scroll key of a cellular telephone to reach screen 146. Screen 146 may provide a user with an opportunity to select a wager application for use. Operation of the wagering application may be blocked and Screen 148 may be displayed when a user selects the wagering application while the user is operating the cellular telephone in a locality in which wagering is illegal. Screen 148 may inform the user that wagering in the current locality is not allowed. The user may then be allowed to use other features or applications that are available on the cellular telephone without allowing wagering to occur using the wagering application. The interactive wagering system may have determined that the cellular telephone is in a locality in which wagering is illegal based on obtaining the identification of a base station that is associated with the cellular telephone and examining the identification against a table of locations and corresponding information on wagering regulations. Such techniques are discussed above.

If desired, screen 150 may be presented when the user selects to use the wagering application from screen 146. Screen 150 may include a main menu of the wagering application. A user may move selection window 152 on different menu items that are available in screen 150, such as the build-a-bet menu item, results menu item, handicap menu item, etc. The build-a-bet menu item may be used to build and submit a wager. Wagering may be blocked and screen 154 may be displayed when a user selects the build-a-bet menu item in a locality in which wagering is illegal. Screen 154 may inform the user that wagering in the current locality is not allowed.

If desired, an icon status indicator may be displayed to inform the user that wagering is currently not allowed. For example, with continued reference to FIG. 12, screen 158 may be displayed that includes icon indicator 156 in a main menu when a user selects the wagering application from screen 146 while operating the cellular telephone in a geographic area in which wagering is illegal. Screen 158 may include indicator 156 for informing the user that wagering is currently unavailable (e.g., unavailable because the device is in a locality in which wagering is illegal). Indicator 156 may be in the shape of a lock and may positioned in screen 156 to be associated with the build-a-bet menu item. A user may not be allowed to select a build-a-bet menu item when indicator 156 is displayed.

Screens 160 and 162 may be displayed when a user is operating a cellular telephone on which a wagering application is implemented in a locality where wagering is not illegal. For clarity and brevity, application and wagering applications discussed herein are primarily discussed in the context of applications that are implemented on mobile wireless communications devices, such as a cellular telephone. Screen 160 that includes a main menu for the wagering application may be displayed when a user selects the wagering application from screen 146. Screen 162 may be displayed that includes a build-a-bet menu when a user selects the build-a-bet menu item from screen 160. Screen 162 may allow a user to select race tracks where races are held. The wagering application may then allow the user to make further selections for building a particular bet and to submit the bet. Examples of interactive wagering systems and methods are shown in U.S. patent application Ser. No. 09/516,730, filed Mar. 1, 2000, which is hereby incorporated herein by reference in its entirety.

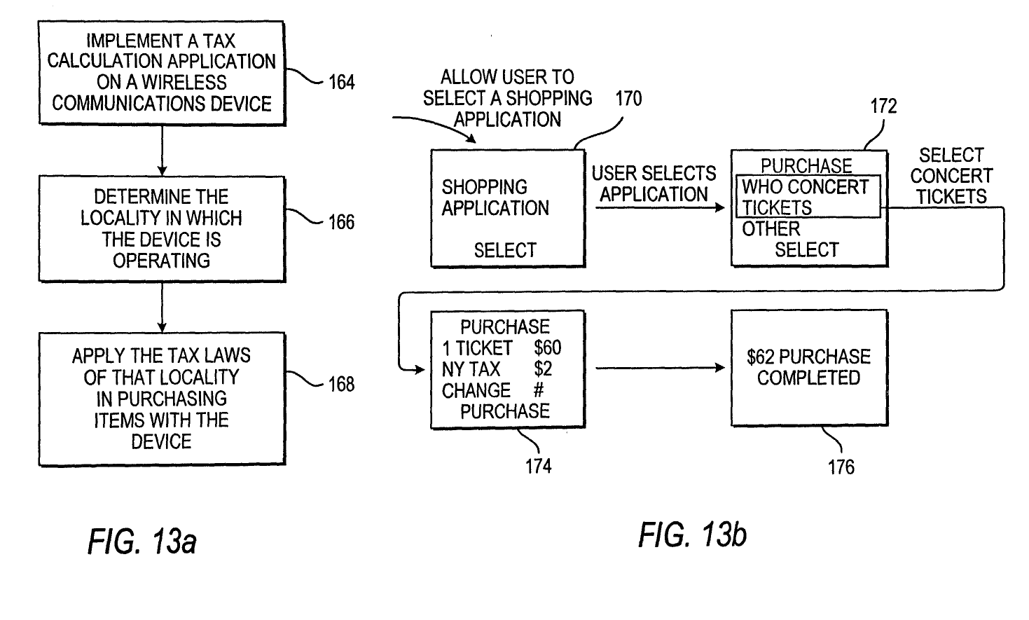

Other applications for mobile wireless communications devices may also be implemented. For example, illustrative steps involved in operating a wireless tax calculation application based on locality information are shown in FIG. 13a. At step 164, a tax calculation application may be implemented on a wireless communications device. The tax calculation application may be part of shopping application or may be an application that is used or automatically used when tax calculations are needed. At step 166, the locality in which the mobile communications device is operating may be determined (e.g., determined automatically). At step 168, information on tax laws for that locality may be determined and applied to an activity that is taken using the cellular telephone, such as the purchase of an item using a shopping application.

In FIG. 13b, an illustrative sequence of screens are shown based on the illustrative steps of FIG. 13a. At screen 170, a user of a cellular telephone may be provided an opportunity to select to use a shopping service with a shopping application. Screen 172 may be presented to provide a user with an opportunity to select shopping items. Screen 174 may be displayed when a user selects an item to purchase, such as concert tickets. Screen 174 may include the price of the item and the appropriate tax on the purchase of that item for the locality in which the device is operating. The tax rate for that locality may have been obtained from a tax table that is stored in memory and current locality information. Calculation of the tax on that item based on the tax rate may be performed at the cellular telephone. Screen 176 may be displayed when a user selects to complete the purchase. Screen 176 may include the total purchase price and the amount of the tax that was applied.

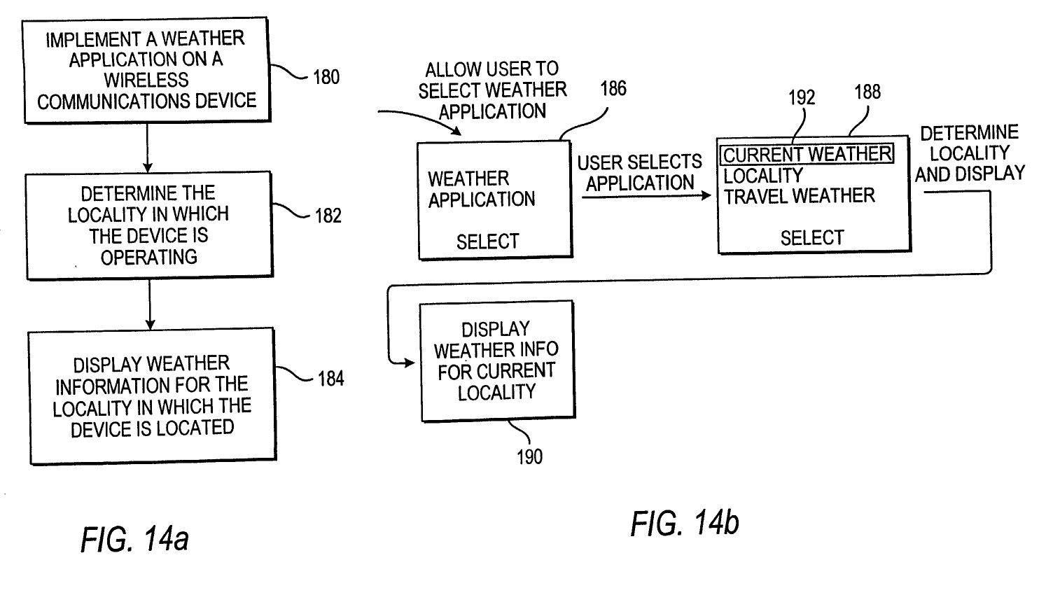

If desired a locality based weather application may be implemented. Illustrative steps involved in operating a weather application based on locality are shown in FIG. 14a. At step 180, a weather application may be implemented on a wireless communications device, such as a cellular telephone. At step 182, the locality in which the device is operating may be determined. At step 184, weather information may displayed using the weather application based on the locality in which the device is operating.

FIG. 14b shows an illustrative sequence of screens that are based on the illustrative steps of FIG. 14a. Screen 186 may be presented to allow a user to select a weather application. Screen 188 may be displayed when a user selects the weather application to provide a menu of weather options. Screen 190 may be presented when a user selects current weather menu item 192 from screen 188. Screen 190 may automatically present weather information for the geographic area in which the device is determined to be operating.

If desired, a travel planner application may be provided that operates in response to user selections based on the locality in which a communications device is operating. At step 192, a travel planner application may be implemented on a mobile wireless communications device. At step 194, the locality in which the device is operating may be determined. The locality may be determined in response to a user selecting a feature of the travel planner application. At step 196, travel information appropriate for that locality may be determined when a user selects to plan a trip.

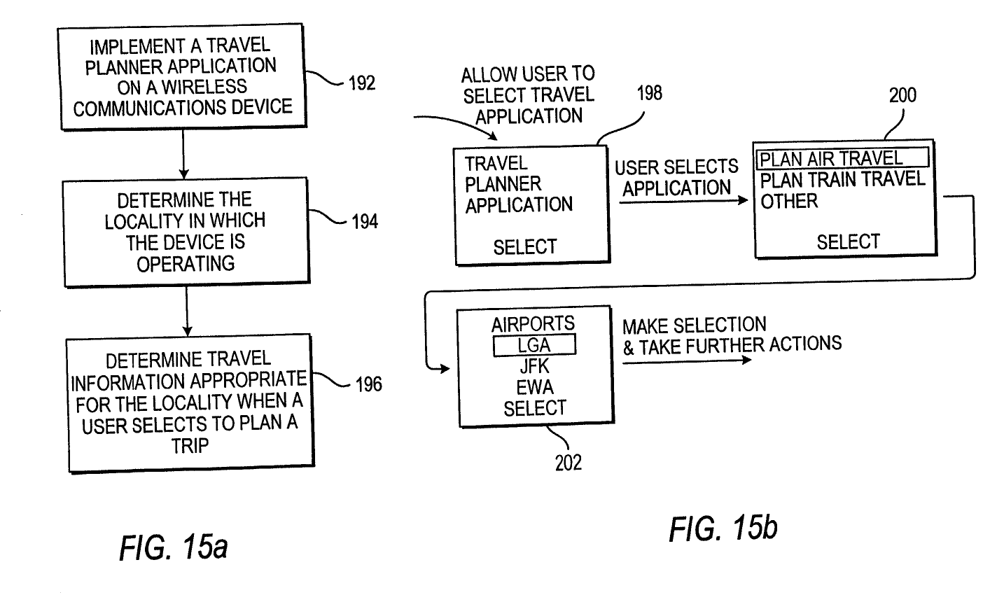

FIG. 15b shows an illustrative sequence of screens based on the illustrative steps of FIG. 15a. Screen 198 may be presented to a user on a cellular telephone to allow the user to select a travel planner application. Screen 200 may presented when a user selects to use the travel planner application. Screen 200 may allow the user to select to plan air travel, select to plan train travel, etc. Screen 202 may be displayed when a user selects to plan air travel. The application may determine the current locality in which the cellular telephone is operating and determine the airports that serve that geographic area, screen 202 may include a list of the airports for that geographic area. A user may select one of the airports and be presented with further screen for planning, reserving, and/or purchase travel transportation and accommodations.

The foregoing is merely illustrative of the principles of this invention and various modifications can be made by those skilled in the art without departing from the scope and spirit of the invention.

What is claimed is:

1. A method for use in an interactive system comprising a mobile wireless communications device, comprising:
providing a mobile wireless communications device that is operable in a wireless communications network in a plurality of localities;
implementing a user-interactive application to provide a specific service in the interactive system that is accessed from the mobile wireless communications device;
determining in which one of a plurality of localities a user is currently operating the mobile wireless communications device; and
responding to the user's selections that are related to the application differently based on which one of the localities the user is in.

2. The method of claim 1 wherein determining comprises determining in which one of a plurality of localities the user is currently operating the mobile communications device based on from which part of the network the mobile wireless communications device is accessing the interactive system.

3. The method of claim 1 wherein determining comprises determining in which one of a plurality of localities the user is currently operating the mobile communications device based on with which one of a plurality of base stations the mobile wireless communications device is associated.

4. The method of claim 1 wherein providing comprises providing a cellular telephone to be the mobile wireless communications device.

5. The method of claim 1 wherein responding comprises providing a table that includes location information and corresponding rules for different localities.

6. A method for use in an interactive system comprising a mobile wireless communications device, comprising:
providing a mobile wireless communications device that is operable in a wireless communications network in a plurality of localities;
implementing a user-interactive application to provide a specific service in the interactive system that is accessed from the mobile wireless communications device;
determining in which one of a plurality of localities a user is currently operating the mobile wireless communication device based on which one of a plurality of base stations the mobile wireless communications device is currently associated with; and
responding to the user's selections that are related to the application differently based on which one of the localities the user is in.

7. The method of claim 6 wherein providing comprises providing a cellular telephone to be the mobile wireless communications device.

8. The method of claim 6 wherein responding comprises providing a table that includes location information and corresponding rules for different localities.

9. The method of claim 6 wherein responding comprises responding differently based on which one of the localities the user is currently in when the user selects to access the specific service.

10. A method for use in an interactive wagering system comprising a mobile wireless communications device that is operable in a wireless communications network in a plurality of localities, comprising:
implementing a user-interactive wagering application to provide a wagering service that is operable to a user from the mobile wireless communications device;
determining in which one of the localities the user is currently operating the mobile wireless communication device based on which one of a plurality of base stations the mobile wireless communications device is associated with; and
preventing the user from wagering using the wagering application when the mobile wireless communications device is being operated in a locality where wagering is not legal.

11. The method of claim 10 further comprising comprises providing a cellular telephone to be the mobile wireless communications device.

12. The method of claim 10 wherein preventing comprises providing a table that includes location information and corresponding rules for different localities.

13. The method of claim 10 wherein responding comprises responding differently based on which one of the localities the user is currently in when the user selects to access the specific service.

14. An interactive system comprising a mobile wireless communications device that is operable in a wireless communications network in a plurality of different localities, comprising:
the interactive system being configured to have a user-interactive application implemented thereon to provide a specific service that is operable to a user from the mobile wireless communications device, to determine in which one of the localities a user is currently operating the mobile wireless communication device, and configured to respond differently to the user's selections that are related to the application based on which one of the different localities the user is in.

15. The system of claim 14 wherein the interactive system is configured determine in which one of a plurality of localities the user is currently operating the mobile communications device based on from which part of the network the mobile wireless communications device is accessing the interactive system.

16. The system of claim 14 wherein the interactive system is configured to determine in which one of a plurality of localities the user is currently operating the mobile communications device based on with which one of a plurality of base stations the mobile wireless communications device is associated.

17. The system of claim 14 wherein mobile wireless communication device is a cellular telephone.

18. The system of claim 14 wherein the interactive system is configured to include a table that includes location information and corresponding rules for different localities.

19. An interactive system comprising a mobile wireless communications device that is operable in a wireless communications network in a plurality of different localities, comprising:
the interactive system being configured to have a user-interactive application implemented thereon to provide a specific service that is operable to a user from the mobile wireless communications device, to determine in which one of the localities a user is currently operating the mobile wireless communication device based on with which one of a plurality of base stations the mobile wireless communications device is associated, and configured to respond differently to the user's selections that are related to the application based on which one of the different localities the user is in.

20. The system of claim 19 wherein the mobile wireless communications device is a cellular telephone.

21. The system of claim 19 wherein the interactive system is configured to include a table that includes location information and corresponding rules for different localities.

22. The system of claim 19 wherein the interactive system is configured to respond differently based on which one of the localities the user is currently in when the user selects to access the specific service.

23. An interactive wagering system comprising a mobile wireless communications device that is operable in a wireless communications network in a plurality of different localities, comprising:
the interactive wagering system being configured to have a user-interactive wagering application implemented thereon to provide a wagering service that is operable to a user from the mobile wireless communications device, to determine in which one of the localities a user is currently operating the mobile wireless communication device, and configured to respond differently to the user's selections that are related to the wagering application based on which one of the different localities the user is in.

24. The interactive wagering system of claim 23 wherein the mobile wireless communications device comprises a cellular telephone.

25. The interactive wagering system of claim 23 wherein the interactive system is configured to include a table that includes location information and corresponding wagering rules for different localities.

26. The interactive wagering system of claim 23 wherein the interactive system is configured to respond differently based on which one of the localities the user is currently in when the user selects to access the specific service.
